(19) United States
(12) Patent Application Publication
(10) Pub. No.: US 2006/0209273 A1
(43) Pub. Date: Sep. 21, 2006

(54) AUTO-TURNING ON/OFF MODULE AND METHOD THEREOF

(76) Inventors: Chien-Yi Yang, Miao-Li County (TW); Chien-Wu Yen, Miao-Li County (TW); Chih-Nan Wu, Miao-Li County (TW)

Correspondence Address: NORTH AMERICA INTELLECTUAL PROPERTY CORPORATION, P.O. BOX 506, MERRIFIELD, VA, 22116, US

(21) Appl. No.: 11/307,682

(22) Filed: Feb. 16, 2006

(30) Foreign Application Priority Data
Mar. 16, 2005 (TW) 094107982

(51) Int. Cl. G03B 21/00

(52) U.S. Cl. 353/122

(57) ABSTRACT

An auto-turning on/off module is used for controlling projection apparatus to process an auto-turning on/off action according to an auto-turning on/off procedure and comprises a first central processing unit, a second central processing unit and a memory. The first and the second central processing unit are disposed in the projection apparatus and electrically coupled with each other. Furthermore, the memory is electrically coupled with the first central processing unit and/or the second central processing unit to use for recording an execution state of the auto-turning on/off immediately. Besides, an auto-turning on/off method is to turn on the projection apparatus first and then to input a turning on/off parameter into the projection apparatus to build the auto-turning on/of procedure. Thereafter, it is to execute the auto-turning on/off procedure and record the execution state of the auto-turning on/off immediately through the memory.

### BACKGROUND OF THE INVENTION

1. Field of the Invention

The present invention relates to an auto-turning on/off module and method, and more particularly to an auto-turn on/off module and method applied in a projection apparatus.

2. Description of Related Art

For allowing a projection apparatus to be conveniently applicable on a situation that the projection apparatus is not easy to be turned on/off or many projection apparatuses are operated simultaneously (e.g. a commercial billboard or production line), saving the power of the projection apparatus, and extending the use life thereof, a set of auto-turning on/off module is installed in a projection apparatus to control the turning-on or the turning-off state of the projection apparatus. A user can set a period of the turning-on or the turning-off of the projection apparatus through an operation interface, and use the turning on/off module to calculate the timings of the turning-on and the turning-off of the projection apparatus to enable the projection apparatus to execute the turning-on or the turning-off action automatically according to an automatic turning on/off procedure. When the power applied to the projection apparatus is terminated, the automatic on/off procedure is being executed at the first place and then terminated. Because the conventional turning on/off module has no way to record the automatic turning on/off state of the projection apparatus before the power is terminated, the turning on/off module recalculates the preset automatic turning on/off period when the power is applied again. Therefore, the time of the turning on/off of the projection apparatus is caused to increase, and a use time of a light bulb in the projection apparatus is caused to increase so that the life of the light bulb is shortened.

Moreover, when a single power is applied to many projection apparatus and is applied to these projection apparatuses again after the power is terminated, these projection apparatuses are turned on simultaneously; it causes the power to be overload easily. This might cause fire to be happened easily.

### SUMMARY OF THE INVENTION

One object of the present invention is to provide an auto-turn on/off module, enabling an auto-turning on/off procedure to continue to be executed after a power failure happens and power is applied again.

Another object of the present invention is to provide an auto-turning on/off method, enabling an auto-turning on/off procedure to continue being executed after a power failure happens and power is applied again.

An auto-turning on/off module is used for controlling projection apparatus to process an auto-turning on/off action according to an auto-turning on/off procedure and comprises a first central processing unit, a second central processing unit and a memory. The first and the second central processing unit are disposed in the projection apparatus and electrically coupled with each other. Furthermore, the memory is electrically coupled with the first central processing unit and/or the second central processing unit to use for recording an execution state of the auto-turning on/off immediately. Besides, an auto-turning on/off method is to turn on the projection apparatus first and then to input a turning on/off parameter into the projection apparatus to build the auto-turning on/of procedure. Thereafter, it is to execute the auto-turning on/off procedure and record the execution state of the auto-turning on/off immediately through the memory.

### BRIEF DESCRIPTION OF THE DRAWINGS

The present invention can be more fully understood by reference to the following description and accompanying drawings, in which:

FIG. 1 is a schematic view of a projection apparatus of a first preferred embodiment according to the present invention;

FIG. 2 is a flow chart of an auto-turning on/off method according to the present invention;

FIG. 3 is a schematic view of a projection apparatus of a second preferred embodiment according to the present invention;

FIG. 4 is a schematic view of a projection apparatus of a third preferred embodiment according to the present invention;

FIG. 5 is a schematic view of a projection apparatus of a fourth preferred embodiment according to the present invention; and

FIG. 6 is a schematic view of multiple projection apparatuses of a fifth preferred embodiment according to the present invention;

### DETAILED DESCRIPTION OF THE PREFERRED EMBODIMENTS

### First Preferred Embodiment

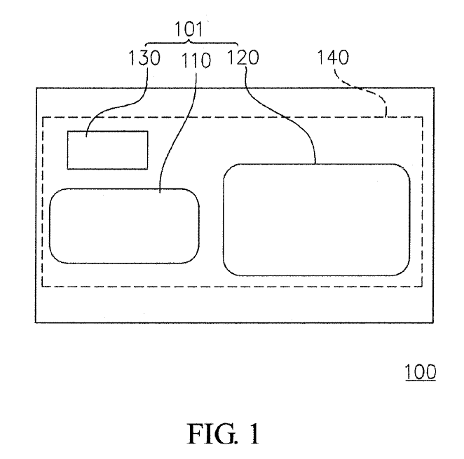

Please refer to FIG. 1. An auto-turning on/off module 101 is disposed in a projection apparatus 100. The auto-turning on/off module 101 comprises a first central processing unit 110, a second central processing unit 120, a memory 130 and a circuit board 140. The first central processing unit 110 is used for turning on the projection apparatus and counting the turning-on period of the projection apparatus according to an auto-turning on/off procedure, and the second central processing unit 120 is used for turning off the projection apparatus and counting the turning-off period of the projection apparatus according the auto-turning on/off procedure. Moreover, the first central processing unit 110 and the second central processing unit 120 are electrically coupled with each other, for example, through the circuit board 140. When the turning-on period calculated by the first central processing unit 110 is reached a predetermined turning-on period, such as eight hours, and then the first central processing unit 110 transmits a signal to the second central processing unit 120. When the second central processing unit 120 receives the signal from the first central processing unit 110, and then the second central processing unit 120 processes the calculations of the turning-on period and the turning-off period. Similarly, when the turning-off period calculated by the second processing unit 120 is reached a predetermined turning-off period, such as eight hours, and then the second processing unit 120 transmits a signal to the first central processing unit 110. When the first central processing unit 110 receives the signal from the second central processing unit 120 the first central processing unit 110 processes the calculations of the turning-on period and the turning-off period. Besides, the memory 130 is also electrically coupled with the first central processing unit 110 and/or the second central processing unit 120 through the circuit board 140 so as to record the an execution state of the auto-turning on/off procedure of the projection apparatus 100 immediately.

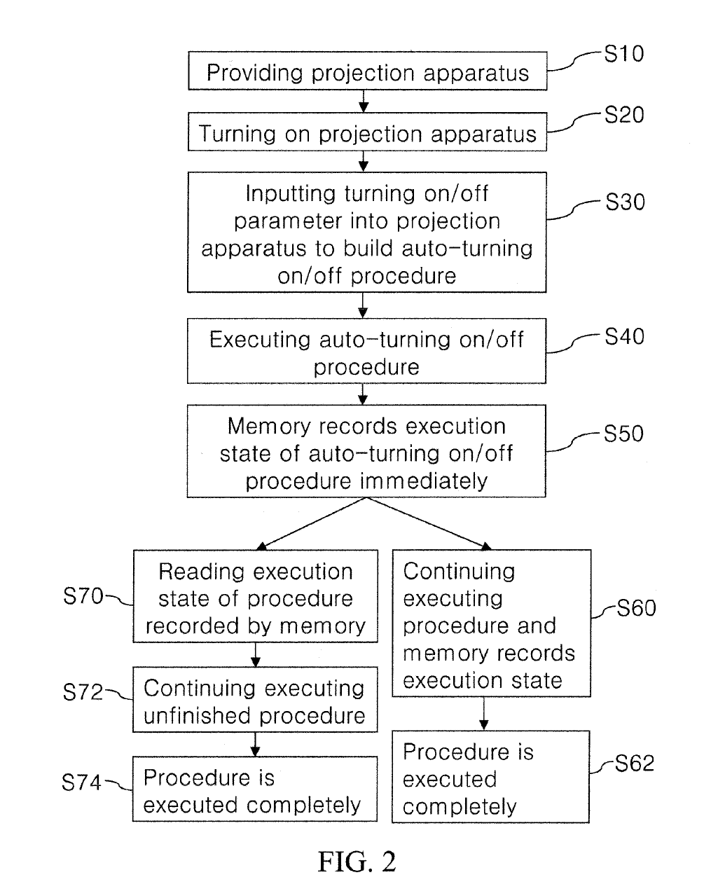

FIG. 2 is a flow chart, shown an auto-turning on/off method according to the present invention. Please refer to FIG. 1 as well as FIG. 2. First, the projection apparatus 100 is provided as Step S10 shown. And then, the projection apparatus 100 is turned on as Step S20 shown. Thereafter, as Step S30 shown, a user inputs a turning on/off parameter into the projection apparatus 100 to build an auto-turning on/off procedure of the projection apparatus. The turning on/off parameter includes a predetermined turning-on period, a predetermined turning-off period, and turning on/off execution times, and etc. Thereafter, as Step S40 shown, the projection apparatus 100 executes the auto-turning on/off procedure according to the turning on/off parameter. As Step S50 shown, the memory 130 records the execution state of the auto-turning on/off procedure of the projection apparatus 100 immediately and the projection apparatus 100 executes the auto-turning on/off procedure at the same time. Furthermore, the first central processing unit 110 calculates the turning-on time during the projection apparatus 100 is turned on, and the second central processing unit 120 calculates the turning-off time during the projection apparatus 100 is turned off. It is deserved to mention that the memory 130 records (or renews) the execution state of the auto-turning on/off procedure of the projection apparatus 100 every a specific period. The specific period can be set according to the requirement of the use, the turning on/off parameter input by the users or an original setting of the projection apparatus 100. Next, if a power continues being provided to the projection apparatus 100 and the power is not terminated, as Step S60 shown, the projection apparatus 100 continues executing the auto-turning on/off procedure, and the memory 130 records the execution state of the turning on/off procedure of the projection apparatus 100 immediately. Finally, as Step S62 shown, the auto-turning on/off procedure of the projection apparatus 100 is executed completely, and then the procedure is stopped.

Please refer to FIGS. 1 and 2 again. In a situation that the power is broken down and supplied again, there are a few ways for executing the auto-turning on/off procedure as the followings:

1. As Step S70 shown, the first central processing unit 110 will automatically read the execution state of the auto-turning on/off procedure recorded (or renewed) at the last time in the memory 130. And then, the auto-turning on/off module 101 allows the projection apparatus 100 to continue executing the unfinished auto-turning on/off procedure according to the newest execution state of the auto-turning on/off procedure. Concretely speaking, when the power is terminated and supplied again, the first central processing unit 110 reads the execution state or the auto-turning on/off procedure in the memory 130 and judge the execution state of the auto-turning on/off procedure to allow the first central processing unit 110 or the second central processing unit 120 to continue executing the unfinished auto-turning on/off procedure of the projection apparatus 100 as Step S72 shown. Finally, as Step S74 shown, the auto-turning on/off procedure of the projection apparatus 100 is executed completely, and then the procedure is stopped.

2. The first central processing unit 110 first supplies power to the second processing unit 120, and the first central processing unit 110 and the second central processing unit 120 respectively read and judge the execution state of the auto-turning on/off procedure recorded (or renewed) at the last time in the memory 130, and execute the unfinished auto-turning on/off procedure after. Finally, the auto-turning on/off procedure of the projection apparatus 100 is executed completely, and then the procedure is stopped.

### Second Preferred Embodiment

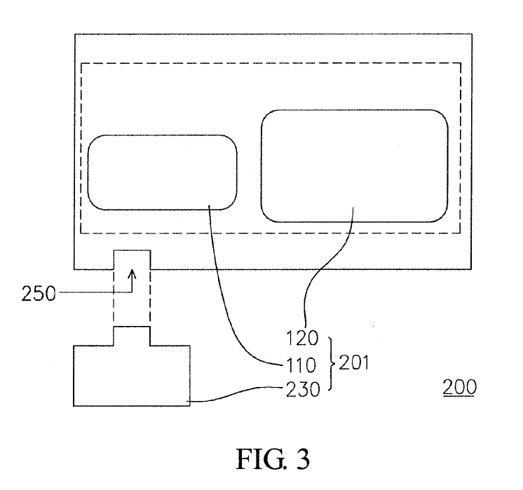

Please refer to FIG. 3, a projection apparatus 200 has a connecting port 250 and an auto-turning on/off module 201. The auto-turning on/off module 201 comprises the first central processing unit 110, the second central processing unit 120 and a memory 230. The first central processing unit 110 is used for turning on the projection apparatus 200 according to an auto-turning on/off procedure, and the second central processing unit 120 is used for turning off the projection apparatus 200 according the auto-turning on/off procedure. Besides, the central processing unit 110 is coupled electrically to the second central processing unit 120. When the turning-on period calculated by the first central processing unit 110 is reached a predetermined turning-on period, the first central processing unit 110 transmits a signal to the second central processing unit 120. The second central processing unit 120 receives the signal from the first central processing unit 110 and then it processes the calculations of the turning-on period and the turning-off period. Similarly, the turning-off period calculated by the second processing unit 120 is reached a predetermined turning-on period, and then it transmits a signal to the first central processing unit 110, the first central processing unit 110 processes the turning-on and the calculation of the turning-on period immediately after it receives the signal. It is special that the memory 230 is installed outside of the projection apparatus 200 and for example, is a cassette. The memory 230 is connected with the connecting port 250 of the projection apparatus 20, for example, by way of the insertion or other ways to be electrically coupled with the first central processing unit 110 and/or the second central processing unit 120 through the connecting port 250 so as to record the execution state of the auto-turning on/off procedure of the projection apparatus 200 immediately.

Please refer to FIGS. 2 and 3. The steps S10 to S50, S60 and, S62 in the auto-turning on/off method of this embodiment are the same as the first embodiment so that they are not longer described again. Comparing to the first embodiment, the memory 230 of this embodiment is connected to the projection apparatus 200 through the external connecting port 250. The first central processing unit 110 reads the newest execution state of the auto-turning on/off procedure recorded in the memory 230 when the power supplying to the projection apparatus 200 is broken down and supplied again, as Step S70 shown. Thereafter, the first central processing unit 110 causes the first central processing unit 110 or the second central processing unit 120 to continue executing an unfinished auto-turning on/off procedure of the projection apparatus, as Step S72 shown. Finally, as Step S74 shown, the auto-turning on/off procedure of the projection apparatus 200 is executed completely, and then the procedure is stopped.

### Third Preferred Embodiment

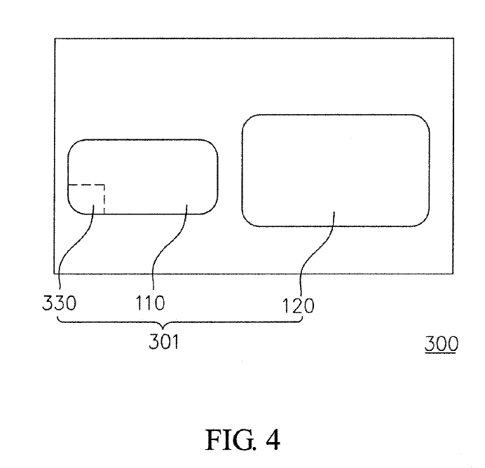

As FIG. 4 shown, an auto-turning on/off module 301 having an auto-turning on/off procedure is disposed in a projection apparatus 300. The auto-turning on/off module 301 comprises the first central processing unit 110, the second central processing unit 120 and a memory 330. The central processing unit 110 is used for turning on the projection apparatus 300 according to the auto-turning on/off procedure, and the second central processing unit 120 is used for turning off the projection apparatus 300 according to the auto-turning on/off procedure, and the first central processing unit 110 and the second central processing unit 120 are electrically coupled with each other. The turning-on period calculated by the first central processing unit 110 is reached a predetermined turning-on period, and then it transmits a signal to the second central processing unit 120. The second central processing unit 120 receives the signal and then it processes the calculations of the turning-off period. Similarly, the turning-off period calculated by the second processing unit 120 a is reached a predetermined turning-off period, such as eight hours, and then it transmits a signal to the first central processing unit 110, the first central processing unit 110 processes the turning-on and the calculation of the turning-on period immediately after it receives the signal. In this embodiment, the memory, for example, is integrated in the first central processing unit 110 or the second central processing unit 120, and records the execution state of the auto-turning on/off procedure of the projection apparatus 300 immediately by being electrically coupled with the first central processing unit 110 or the second central processing unit 120.

Please refer to FIGS. 2 and 4. The steps S10 to S50, S60 and S62 in the auto-turning on/off method of this embodiment are the same as the first embodiment so that they are not longer described again. Comparing to the first and the second embodiments, the memory 330 in this embodiment is integrated in the first central processing unit 110 or the second central processing unit 120. When the power of the projection apparatus 300 is terminated and supplied again, as FIG. S70 shown, the first central processing unit 110 supplies the power to the second central processing unit 120 to cause the second central processing unit to read the newest execution state of the auto-turning on/off procedure recorded by the memory 330. Thereafter, the auto-turning on/off module 301 continues executing the unfinished auto-turning on/off procedure of the projection apparatus, as Step S72 shown, and it does not need a user to reset it. Finally, as Step S74 shown, the auto-turning on/off procedure of the projection apparatus is executed completely, and then the procedure is stopped.

### Fourth Preferred Embodiment

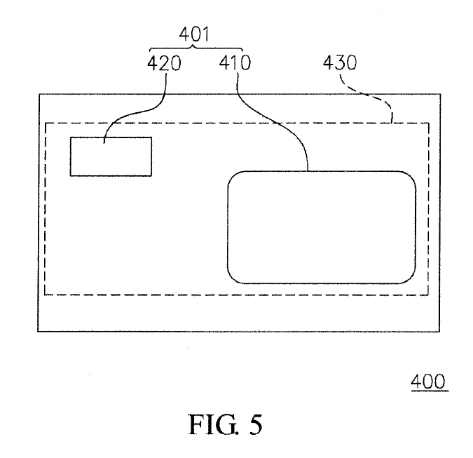

FIG. 5 is a schematic view, shown a projection apparatus of a fourth preferred embodiment of the present invention. As FIG. 5 shown, an auto-turning on/off module 401 is disposed in a projection apparatus, the auto-turning on/off module 401 comprises a single central processing unit 410 and a memory 420, and the central processing unit 410 and the memory 420 are electrically coupled with each other. Besides, the auto-turning on/off module 401 further comprises a circuit board 430 to allow the central processing unit 410 and the memory 420 to be electrically coupled through, for example, the circuit board 430.

It is noticed that the memory 420 in this embodiment is electrically coupled with the central processing unit 410 through, for example, the circuit board 430. The memory 420 can be similar to the one in the third embodiment, and it can be integrated, for example in the central processing unit 410 so as to record the execution state of the auto-turning on/off procedure of the projection apparatus 400 immediately. The memory 420 can even more be similar to the second embodiment, it is, for example, a cassette (not shown), and connected with a connecting port (not shown) of the projection apparatus 400 by means of the insertion or other ways. Furthermore, the memory 420 is electrically coupled with the central processing unit 410 so as to record the execution state of the aut0-turning on/off procedure of the projection apparatus 400 immediately.

Please refer to FIGS. 2 and 5. The steps S10 to S50, S60 and S62 in the auto-turning on/off method of this embodiment are the same as the first, the second and the third embodiments so that they are not longer described again. Comparing to the first, the second, and the third embodiments, this embodiment only has a single central processing unit 410, and the central processing unit 410 is used for executing auto-turning on/off procedure. When the power of the projection apparatus 400 is terminated and supplied again, such as Step S70 shown, the central processing unit 410 reads the newest execution state of the auto-turning on/off procedure recorded by the memory 420. Thereafter, the auto-turning on/off module 401 continues executing the unfinished auto-turning on/off procedure of the projection apparatus 400 without resetting. Finally, as Step 74 shown, the auto-turning on/off procedure of the projection apparatus 400 is executed completely, and then the procedure is stopped.

### Fifth Preferred Embodiment

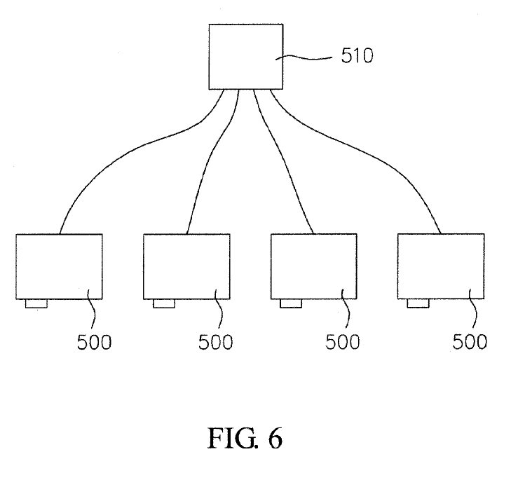

Please refer to FIG. 6 The fifth preferred embodiment is to apply an auto-turning on/off module on a plurality of projection apparatuses 500, in which each projection apparatus 500 comprises an auto-turning on/off module (not shown), the auto-turning module in the first, the second, the third and fourth embodiments can be used as the auto-turning on/off module in this embodiment. The projection apparatuses 500 share a single power supply device 510. The power supply device 510 can control the projection apparatuses 500 to process a random turning-on. When the power supplying to the projection apparatuses 500 is terminated and applied again, each projection apparatuses 500 continues executing the unfinished auto-turning on/off procedure. Therefore, if each projection apparatuses 500 is at a turning-off state upon the power failure, it still continue executing the turning-off and calculating the unfinished turning-off period, for example 10 hours, after the power is supplied again, and if each projection apparatuses 500 is at a turning-on state upon the power failure, it still continues executing the turning-on and calculating the unfinished turning-on period after the power is supplied again. Moreover, to the projection apparatuses 500 that are at the turning-on state simultaneously, the power supply device 510 can transmits a signal to control the projection apparatuses 500 to be turned on randomly so as to avoid the danger of the power overload because of the projection apparatuses 500 turned on at the same time.

To sum up, the auto-turning on/off module and the auto-turning on/off method has at least the following merits.

1. A memory used for recording the execution state of the auto-turning on/off procedure of a projection apparatus is disposed in an auto-turning on/off module, and a central processing unit in the auto-turning on/off module first reads the newest execution state of the auto-turning on/off procedure recorded in the memory to continue executing the unfinished auto-turning on/off procedure, if the power supply is terminated and supplied again.

2. The location of the memory can be altered according to a user's requirement in the auto-turning on/off module according to the present invent so that it is fairly convenient.

3. The auto-turning on/off method according to the present invention allows the projection apparatus to continue executing the unfinished auto-turning on/off procedure to ensure the auto-turning on/off period of the projection apparatus to be correct and meet the user's requirement.

4. The auto-turning on/off method according to the present invention allows the projection apparatus to continue executing the unfinished auto-turning on/off procedure automatically and avoid recalculating the turning on/off period. Therefore, the power of the projection apparatus can be saved and the use life of the power can be extended.

5. Under the situation that a plurality of projection apparatuses share a power device, for example, in an exhibition place for the projection apparatuses. Using the auto-turning on/off method in the projection apparatuses, each projection apparatus continues executing the unfinished auto-turning on/off procedure when the power is terminated and supplied again. Therefore, if the projection apparatus is at a turning-off state upon the power failure, it still continue executing the turning-off and calculating the unfinished turning-off period after power is supplied again, and if the projection apparatus is at a turning-on state upon the power failure, it still continue executing the turning-on and calculating the unfinished turning-on period after power is supplied again. Moreover, to the projection apparatuses that are at the turning-on state simultaneously, the power supply device can transmits a signal to control the projection apparatuses to be turned on randomly so as to avoid the danger of power overload because the projection apparatuses are turned on at the same period.

Additional advantages and modifications readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An auto-turning on/off module, used for controlling a projection apparatus to process an auto-turning on/off action according to an auto-turning on/off procedure, said auto-turning on/off module comprising:
a first central processing unit, disposed in said projection apparatus and used for turning on said projection apparatus according to said auto-turning on/off procedure;
a second central processing unit, disposed in said projection apparatus and electrically coupled with said first central processing unit and used for turning off said projection apparatus according to said auto-turning on/off procedure; and
a memory, electrically coupled with said first central processing unit and/or said second central processing unit and used for recording an execution state of said auto-turning on/off procedure immediately.

2. The module according to claim 1, further comprising a circuit board, wherein said first central processing unit, said second central processing unit, and said memory are disposed on said circuit board, and said memory is electrically coupled with said first central processing unit and/or said second central processing unit through said circuit board.

3. The module according to claim 1, wherein said projection apparatus has a connecting port, and said memory is electrically coupled with said first central processing unit and/or said second central processing unit through said connecting port.

4. The module according to claim 1, wherein said memory is integrated in said first central processing unit and/or said second central processing unit.

5. The module according to claim 1, further comprising a power supply device, wherein said power supply device is electrically coupled with said first central processing unit and/or said second central processing unit so as to enable said first central processing unit to turn on said projection apparatus randomly.

6. An auto-turning on/off module, used for controlling a projection device to process an automatic on/off action according to an auto-turning on/off procedure, said auto-turning on/off module comprising:
a central processing unit, disposed in said projection apparatus and used for executing said auto-turning on/off procedure; and
a memory, being electrically coupled with said central processing unit, and used for recording an execution state of said auto-turning on/off procedure immediately.

7. The module according to claim 6, further comprising a circuit board, wherein said central processing unit and said memory are disposed on said circuit board, and said memory is electrically coupled with said central processing unit through said circuit board.

8. The module according to claim 6, wherein said projection apparatus has a connecting port, and said memory is electrically coupled with said central processing unit through said connecting port.

9. The module according to claim 6, wherein said memory is integrated in said central processing unit.

10. The module according to claim 6, further comprising a power supply device, wherein said power supply device is electrically coupled with said central processing unit so as to enable said central processing unit to turn on said projection apparatus randomly.

11. An auto-turning on/off method, used for controlling a projection apparatus to process an auto-turning on/off action, said auto-turning on/off method comprising:
turning on said projection apparatus;
inputting a turning on/of parameter into said projection apparatus to build an auto-turning on/off procedure; and
executing said auto-turning on/off procedure, and recording an execution state of said auto-turning on/off procedure immediately through a memory.

12. The method according to claim 11, wherein said projection apparatus is used for reading said memory and continues executing said auto-turning on/off procedure according an execution state of said auto-turning on/off procedure when an power needed for said projection apparatus is terminated and supplied again.

13. The method according to claim 11, wherein said auto-turning on/off parameter comprises a turning-on period, a turning-off period or an number of times of turning on/off executions.
